(19) United States
(12) Patent Application Publication
(10) Pub. No.: US 2006/0094449 A1
(43) Pub. Date: May 4, 2006

(54) Method and apparatus for preventing communication link degradation due to the disengagement or movement of a self-positioning transceiver

(75) Inventor: Steven Jeffrey Goldberg, Downingtown, PA (US)

Correspondence Address: VOLPE AND KOENIG, P.C.;DEPT. ICC, UNITED PLAZA, SUITE 1600, 30 SOUTH 17TH STREET, PHILADELPHIA, PA, 19103, US

(73) Assignee: InterDigital Technology Corporation, Wilmington, DE (US)

(21) Appl. No.: 11/013,557

(22) Filed: Dec. 16, 2004

Related U.S. Application Data
(60) Provisional application No. 60/622,888, filed on Oct. 28, 2004.

(51) Int. Cl. H04B 7/00; H04Q 7/20

(52) U.S. Cl. 455/456.6; 455/456.1

(57) ABSTRACT

A method and apparatus for preventing the degradation of a communication link formed by a plurality of self-positioning transceivers when at least one of the transceivers changes position and/or disengages from the link. When it is determined that at least one of the transceivers is moving or is going to move, the radio frequency (RF) beam pattern and/or link characteristics of at least one of the transceivers in the link is adjusted to enhance communications. In another embodiment, the RF beam pattern and/or link characteristics are adjusted when it is determined that a gap in the communication link has occurred or will occur because one of the transceivers has disengaged or is going to disengage from the communication link. In other embodiments, the transceivers form beams and/or move based on their true three-dimensional orientation, the results of reflective probing tests and/or the results of boresight signal searching tests.

### CROSS REFERENCE TO RELATED APPLICATION

This application claims priority from U.S. provisional application No. 60/622,888, filed Oct. 28, 2004, which is incorporated by reference as if fully set forth.

### FIELD OF THE INVENTION

The present invention relates to the field of wireless communications. More particularly, the present invention relates to preventing the degradation of a communication link formed by a plurality of self-positioning transceivers when at least one of the transceivers changes position and/or disengages from the link.

### BACKGROUND

In a conventional wireless communication system, beam forming is associated with radio frequency (RF) antenna arrays in the azimuth and elevation vernacular. This is suitable for fixed infrastructure deployments, or wireless transmit/receive units (WTRUs), (e.g., cellular telephones, portable computers (PCs), or the like), with a preferred ad hoc deployment orientation.

Non-mobile ad hoc networks have radio resource functional units which try to sculpt antenna patterns in a system planning fashion. Tracking the movement of WTRUs and adjusting antenna patterns in a reactive fashion has been implemented by conventional wireless communication systems.

When the orientation of a WTRU's antenna with respect to the environment is known, the bore axis, power level, and beam width and depth, are each adjusted in a different fashion for optimum results.

However, the upcoming deployment of an adaptive type antenna on WTRUs cannot guarantee that the terms azimuth and elevation have any immediate relation to a WTRU's utilization of the antenna's adaptive capabilities. For example, WTRUs tossed into handbags and briefcases in a random fashion are still expected to communicate for transport of data, or call alerting to the user, although the device has no knowledge of its own relationship to the Earth. This lack of knowledge is carried over to the antenna system.

Furthermore, the quality of communications provided by a WTRU with a single antenna is diminished due to its poor orientation. Some WTRUs have two antennas, usually 90 degrees out of orientation with each other. For example, a whip antenna may be used for an expected WTRU orientation, and a wrapped core embedded antenna may be used for a less likely WTRU orientation.

Conventional wireless systems are disadvantageous because the WTRUs they service are built with an assumed orientation usage. The use of adaptive antenna methods will at best be suboptimal in usage. For example, the less likely WTRU orientation may cause half of the WTRU's antenna radiated power pattern focused into the ground instead of free air.

Ad hoc communication networks are being developed for numerous uses. For example, U.S. Patent Application Publication 2003/0124977 by Smith et al., entitled “Self-Positioning Wireless Transceiver System and Method,” was published on Jul. 3, 2003 and is incorporated by reference in its entirety herein. This publication discloses a system and method for increasing the communication range of a source device by using a plurality of self-positioning transceivers to form a communication link that otherwise may not be possible using a fixed communication, (e.g., due to excessive traffic, communication obstacles or the like).

As shown in FIG. 1A, the above-mentioned publication discloses a wireless communication system 100 including a “swarm” of self-positioning transceivers T1-T12 which create multiple communication paths between a source device 105 and a destination device 110. The transceivers T1-T12 automatically position themselves with respect to the source device 105 to increase the communication range of the source device 105. When communicative coupling between the source device 105 and a destination device 110 within the increased communication range is detected, the plurality of self-positioning transceivers T1-T12 automatically position themselves and create a communication link between the source device 105 and the destination device 110.

As shown in FIG. 1B, each self-positioning transceiver T, (i.e., T1-T12), shown in the wireless communication system 100 of FIG. 1A, includes a mobility mechanism 115 and a WTRU 120. The mobility mechanism 115 permits the self-positioning transceiver T to adjust its position as necessary to create and/or maintain a particular communication link. The WTRU 120 includes a processor 125, a memory 130, a random access memory (RAM) 135, a transceiver 140 and an antenna 145. The memory 130 includes an operating system, self-positioning software 155 and communication software 160.

During operation, the processor 125 employs the self-positioning software 155 to identify adjustments to the position of the self-positioning transceiver T, relative to neighboring self-positioning transceivers, the source device 105 and/or the destination device 110, as shown in FIG. 1A. Based on the identified adjustments, the processor 125 issues commands to the mobility mechanism 115 to adjust the position of the self-positioning transceiver T.

However, the publication does not disclose how the communication links between mobile facilitators and their ultimate communication targets are coordinated.

Re-active RF pattern adjustment is prone to link loss, reduced data rates, or a general quality of service degradation for the link. To avoid this, the RF patterns can be made much more robust by increasing the beam width, power level, error correction capabilities, or a combination of these characteristics. The problem with this approach is that the damage may already have been done, and/or the interference to other communications in the area can be detrimentally affected by the attempts of this link to maintain its operation.

What is needed is a more robust methodology for positioning transceivers to mitigate degraded link conditions and minimize interference to other communication links in the vicinity.

### SUMMARY

The present invention is related to a method and apparatus for preventing the degradation of a communication link formed by a plurality of self-positioning transceivers when at least one of the transceivers changes position and/or disengages from the link. When it is determined that at least one of the transceivers is moving or is going to move, the radio frequency (RF) beam pattern and/or link characteristics of at least one of the transceivers in the link is adjusted to enhance communications. In another embodiment, the RF beam pattern and/or link characteristics are adjusted when it is determined that a gap in the communication link has occurred or will occur because one of the transceivers has disengaged or is going to disengage from the communication link.

In other embodiments, the self-positioning transceiver form beams and/or change at least one of the transceiver's position and three-dimensional orientation based on 1) the transceiver's true three-dimensional orientation, as sensed by at least one three-dimensional orientation sensor within the transceiver, 2) the results of reflective probing tests and/or 3) the results of boresight signal searching tests.

In yet another embodiment, a network of self-positioning transceivers are directed to deploy in a specific fashion, or self-deploy based on surrounding conditions and the conditions of the communication links they are using.

### BRIEF DESCRIPTION OF THE DRAWINGS

A more detailed understanding of the invention may be had from the following description, given by way of example and to be understood in conjunction with the accompanying drawings wherein:

FIG. 1A shows a conventional self-positioning wireless transceiver system;

FIG. 1B shows a conventional self-positioning transceiver used in the system of claim 1;

FIGS. 2a and 2b show the nomenclature and coordinates used in accordance with the present invention;

FIG. 3a shows the nominal position of a WTRU in accordance with the present invention;

FIGS. 3b and 3c show other exemplary WTRU antenna orientations relative to the true ones in accordance with the present invention;

FIGS. 4a and 4b show different orientations of a sensor used to report to a WTRU the amount of force being exerted in three dimensions;

FIG. 5 illustrates the motion of a particular self-positioning transceiver which triggers link characteristics between the particular transceiver and to its neighboring transceivers in accordance with one embodiment of the present invention;

FIG. 6 illustrates a self-positioning transceiver moving out of the range of a group of self-positioning transceivers in accordance with another embodiment of the present invention; and

FIG. 7 is an exemplary block diagram of a self-positioning transceiver which operates in accordance with the present invention.

### DETAILED DESCRIPTION OF THE PREFERRED EMBODIMENT(S)

The preferred embodiments will be described with reference to the drawing figures where like numerals represent like elements throughout.

Hereafter, the terminology “WTRU” includes but is not limited to a user equipment (UE), a mobile station, a fixed or mobile subscriber unit, a pager, a transceiver, a portable computer (PC), a cellular telephone, or any other type of device capable of operating in a wireless environment.

The features of the present invention may be incorporated into an integrated circuit (IC) or be configured in a circuit comprising a multitude of interconnecting components.

FIGS. 2a and 2b show the nomenclature and coordinates that will be used in accordance with the present invention. As shown, azimuth is an orientation relative to a plane parallel to the Earth, and elevation is an orientation perpendicular to the Earth. A point in space can be referenced by the X, Y, and Z coordinates as shown.

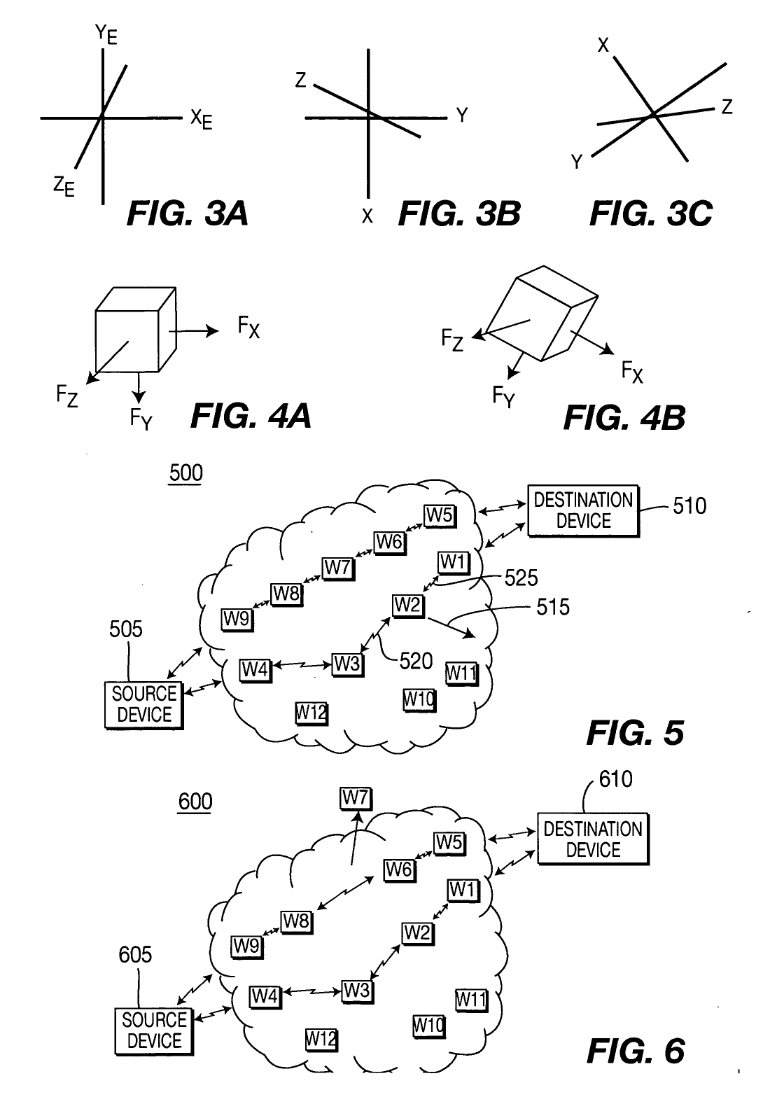

FIG. 3a shows a nominal position the prior art assumes for the WTRU's antenna, with the subscript “E” meaning the true coordinates.

FIGS. 3b and 3c show examples of the WTRU's possible inherent coordinates relative to the true ones in accordance with the present invention. For the prior art to work it must be assumed that the transceivers in each device use an omni directional antenna. This is a problem from several standpoints. It means all devices are transmitting in a fashion that will interfere with other devices, and receive signals from devices in all directions. Interference is therefore maximized. Power transmission in all directions also requires an excessive battery drain on each device.

The present invention enables WTRUs to orientate transmit and receive beams toward intended neighboring units. Signals are then transmitted only in the general direction of intended receivers, causing less interference to other WTRUs. Likewise, receivers receive signals only from the general direction of the transmitters, thus lessening the signals that will be received as interference. Since the transmitters are not sending signals in all directions, the same gain factor towards the intended receiver is achieved with an overall lower power drain on the device.

In one embodiment, internal orientation detection is used to determine the WTRU's true orientation to the Earth coordinate system, and adjust the pattern forming of the WTRU's antenna system to obtain the desired pattern relative to the Earth coordinates. In order for the beams to be oriented in the proper direction, the WTRU needs to know its orientation to Earth. By receiving signals from devices such as those illustrated in FIGS. 4a and 4b, the WTRU can determine its true orientation, such as those shown in FIGS. 2b and 2c. The WTRU can therefore orient its beams in any desired direction, which will usually be parallel to the Earth, as opposed, for example, to pointing the beam towards a surface above or below a desired target receiver.

A physical tracking device may be used to determine the orientation of the WTRU. Examples of physical tracking devices include fluid detectors, pendulums, gyroscopes and weight sensors. All of these physical tracking devices may be created in the form of micro-electro-mechanical systems (MEMS) for low cost and insignificant size requirements. For example, FIGS. 4a and 4b show different orientations of a sensor used to report to a WTRU the amount of force being exerting in three dimensions.

The physical tracking device is used to track a WTRU while communications are underway after any one of the other above-mentioned methods is used to determine the initial orientation of the WTRU. The physical gyroscope method can also be used by the user issuing an orientation command telling the device when it is in a specific orientation. While an object, such as a WTRU, may change its orientation, an unencumbered gyroscope therein will maintain a constant orientation to the gravitational field of the Earth. By sensing the gyroscope's orientation to the containing device, (i.e., the WTRU), the true ground reference vector necessary for determining three-dimensional axis rotational equations can be determined.

Once the deviation from the true Earth orientation is known, the correction factor can be calculated for the bore axis. The appropriate equations are dependant on the information available from the orientation determination method or methods available.

The following are general three dimensional axis rotational equations that can be adapted for this application.

True ground referenced vector is defined as follows:
(a, b, c)=R[x, y, z] Equation (1)
where the Euler angles (α,β,γ) are defined as follows: α is the rotation around the x-axis, β is the rotation around the y-axis, and γ is the rotation around the x-axis.

$$\begin{matrix}R = [ \begin{matrix}cos ( α ) cos ( β ) cos ( γ ) - sin ( α ) sin ( γ ) & - sin ( α ) cos ( β ) cos ( γ ) - cos ( α ) sin ( γ ) & sin ( β ) cos ( γ ) \\ sin ( α ) cos ( γ ) + cos ( α ) cos ( β ) sin ( γ ) & - sin ( α ) cos ( β ) sin ( γ ) + cos ( α ) cos ( γ ) & sin ( β ) sin ( γ ) \\ - cos ( α ) sin ( β ) & sin ( α ) sin ( β ) & cos ( β )\end{matrix} ] , \\ & Equation ( 2 ) \\ α = \frac{a}{\sqrt{{a}^{2} + {b}^{2} + {c}^{2}}} , & Equation ( 3 ) \\ β = \frac{b}{\sqrt{{a}^{2} + {b}^{2} + {c}^{2}}} , \\ and & Equation ( 4 ) \\ γ = \frac{c}{\sqrt{{a}^{2} + {b}^{2} + {c}^{2}}} . & Equation ( 5 )\end{matrix}$$

Determination of the Euler angles in accordance with Equations 3, 4 and 5 are used to rotate the exemplary arbitrary rotations of FIGS. 3b and 3c to the nominal orientation of 3a.

FIGS. 4a and 4b show a sensor that can report the force being exerting in three dimensions.

FIG. 4a shows the nominal position of the Y axis as being perpendicular to the ground, and the Y axis and Z axis as being parallel to the ground. In this ideal case, the values would be F_{Y}=F_{Max}, F_{X}=0, and F_{Z}=0.

FIG. 4b shows the sensor being rotated away from the nominal position of shown in FIG. 4a. The angles to adjust the coordinates of the sensor, and therefore of the device, (e.g., the WTRU), it is embedded into, is defined as follows:

$$\begin{matrix}α = - {cos}^{- 1} ( \frac{{F}_{Y}}{\sqrt{{F}_{X}^{2} + {F}_{Y}^{2} + {F}_{Z}^{2}}} ) , & Equation ( 6 ) \\ β = - {sin}^{- 1} ( \frac{{F}_{X}}{\sqrt{{F}_{X}^{2} + {F}_{Y}^{2} + {F}_{Z}^{2}}} ) , \\ and & Equation ( 7 ) \\ γ = - {sin}^{- 1} ( \frac{{F}_{Z}}{\sqrt{{F}_{X}^{2} + {F}_{Y}^{2} + {F}_{Z}^{2}}} ) . & Equation ( 8 )\end{matrix}$$

The three values being reported by a single sensor in FIGS. 4a and 4b could be also be provided by separate sensors mounted orthogonal to each other. Likewise, non-orthogonal sensors could be used, with the appropriate orientation angles taken into account when performing the calculations.

Another approach is to modify the sensor embedded within the WTRU, so that it is forced to rotate with the WTRU, but provide as means to detect any such forced rotation. U.S. Pat. No. 6,796,179 entitled “Split-Resonator Integrated-Post MEMS Gyroscope,” which was issued to Bae et al. on Sep. 28, 2004, discloses an example of a micro-sized device suitable for implementing the features of the sensor disclosed herein in accordance with the present invention.

In another embodiment, reflective probing may be implemented by sending a test transmission and examining the effects, or lack of them, based on voltage standing wave ratio (VSWR) measurements and receiver interceptions. When an RF signal is transmitted from an antenna, some of the energy may be reflected back into the antenna. This causes a VSWR value to deviate from an ideal ratio value of one. By transmitting test signals at various boresight orientations, and measuring the associated VSWR values, it can be determined where there are obstructions, as the VSWR measurement readings will appear as higher deviations from one. Furthermore, this technique may be used to determine which directions the WTRU can best send signals. In most applications, this will also be a good indication of the best receive directions. In the best case, reciprocity of the channel is applicable. In the case of physical blockage however, reciprocity is not a necessity to determine the best directional characteristics.

In yet another embodiment, signal orientation may be implemented by using boresight signal searching techniques in all the WTRU's degrees of available freedom to determine the appropriate orientation for receive and transmission boresight directions. Once the information is determined, there are a number of possible uses for the determined orientation, as described below.

In one embodiment, the formation of the antenna beam pattern of the WTRU and other transmitter or receiver characteristics are adjusted as is appropriate to determine the orientation of true ground. The antenna beam pattern of the WTRU may be adjusted taking into account the limitations of the beam pattern control available in the WTRU or measured signal characteristics, such as VSWR, receiver interceptions, boresight signal searching techniques, reflective probing and/or signal orientation.

The ability to adjust beam patterns will vary considerably from one implementation to another. Some devices, such as InterDigital's Trident antenna, have only left, right and omni beam patterns. Other implementations, especially those using phased array techniques, can finely adjust RF antenna pattern boresights in single degree resolutions. The control of the beam width of the WTRUs will also come into play, and may considerably vary depending upon the complexity of the design.

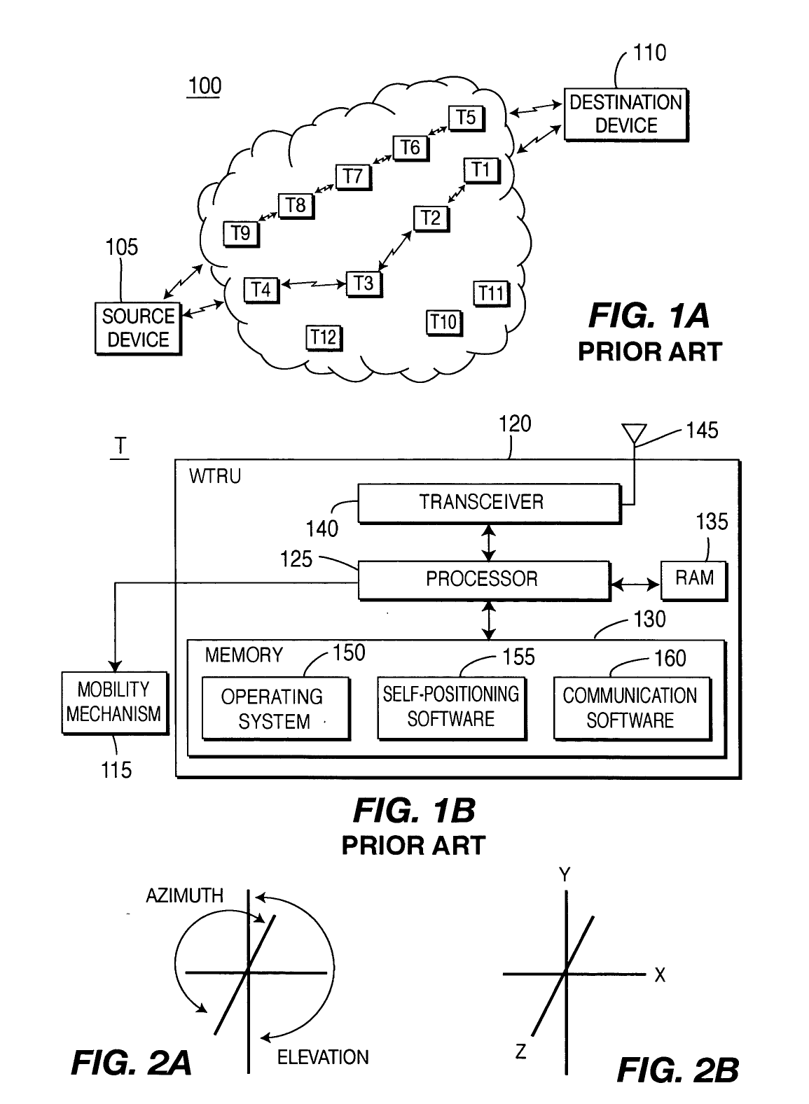

FIG. 5 shows a wireless communication system 500 including a “swarm” of self-positioning transceivers W1-W12 which create multiple communication paths between a source device 505 and a destination device 510. However, unlike the conventional system 100 shown in FIG. 1A, when a self-positioning transceiver W2 in the system 500 moves in a particular direction 515, the characteristics of the sublinks 520 and 525 between the transceiver W2 and its neighboring transceivers W1 and W3 are changed in accordance with one embodiment of the present invention. For example, the transceivers W1, W2, and/or W3 may adjust their RF patterns and link modulation characteristics to maintain an adequate link during the movement, and minimize interference to other links.

In a directed movement case, the sender of the movement instructions is aware of relative motion of the directed transceiver. However, self-deploying transceivers may send their anticipated movement information to the transceivers they are communicating with. With this information, all of the transceivers involved in the associated communication links may adjust their RF beam patterns so as to maintain adequate communications, while minimizing the potential interference to other links.

The information known by each entity prior to execution, either by it being the director of the movement, or receiving data from another entity, may be implemented using numerous techniques as described below.

The information may indicate absolute or relative time to execution of movement in one, two, or three dimensions. Knowledge of the time when the change will occur allows the necessary changes to the beams to be calculated. Thus, preparations can be made prior to implementation when the time mark occurs. Absolute time refers to all transceivers within the network maintaining a common time. The information is therefore transferred as a time mark of this common time. Relative time is used when no common time is available. One transceiver may estimate from its transmission of the information when the change will occur, and send that information. Absolute common time is preferable in that it is insensitive to random delays in communication, but is not always available all networks.

The information may indicate absolute or relative change in position in one, two, or three dimensions. Absolute positioning may be available for fixed position transceivers, transceivers equipped with a positioning ability such as a Global Positioning System (GPS), or a system ability to provide absolute positioning coordinates. Relative changes are movements derived from known speed and directions relative to some common coordinate system, or based on the prior condition of the transceiver. Absolute positioning, when available, tends to be more accurate and less prone to cumulative errors than relative positioning.

The information may indicate absolute or relative velocities in each of three dimensions. Velocities, their directions, and duration define ongoing information that allow for contiguous adjustments of RF antenna beams.

The information may indicate a schedule of times associated with absolute or relative movements as described above. This provides an ongoing set of information that allows for more timely adjustments of the RF antenna beams.

The information may indicate a margin of error associated with the movements. The margin of error along with the known resolution limitations of the RF antenna beams allows for the minimal adjustments to be selected to maintain a link.

The information may indicate a change in the characteristics of each communication pattern, either in transmit, receive, or both consisting of some full or subset of signal gain, beam width in elevation, azimuth, or both, or boresight direction in elevation, azimuth, or both (absolute of relative).

Finally, the information may indicate a change in each communication link related to physical modulation, error detection and correcting codes, channel utilization, timing settings, timing margins, or the like. The projected robustness of the link due to the changes in positioning and the capabilities of the RF antenna beams may determine the link margin of the link. Depending on this link margin, non-beamforming changes may be modified to further strengthen the link when the other means are inadequate, or conversely may be reduced to increase the data rate when the beam means improves the link margin.

FIG. 6 shows a wireless communication system 600 including a “swarm” of self-positioning transceivers W1-W12 which create multiple communication paths between a source device 605 and a destination device 610. However, unlike the conventional system 100 shown in FIG. 1A, when information indicates that a self-positioning transceiver W7 in the system 600 is going to disengage, (i.e., all of the other transceivers W1-W6 and W8-W12 are moving as a group away from the transceiver W7), the sublink between transceivers W7 and W8, and the sublink between transceivers W7 and W6, are broken. A determination is made as to whether or not there is another self-positioning transceiver available to fill in the gap left by the transceiver W7 in order to reestablish a broken sublink between transceivers W6 and W8. Furthermore, information maintained concerning the relative positions of transceivers W6 and W8, and their link relationships with transceiver W7, may also be used to determine the characteristics best assigned to one or more new links.

By utilizing the pro-active nature of the present invention, the loss of a connection between two transceivers may be minimized, or eliminated completely. This involves the options listed above plus the option of requesting motion from one or more of the other devices, self-motion by the device, or the substitution arrival of another device to join a transceiver link chain in the wireless communication system 600.

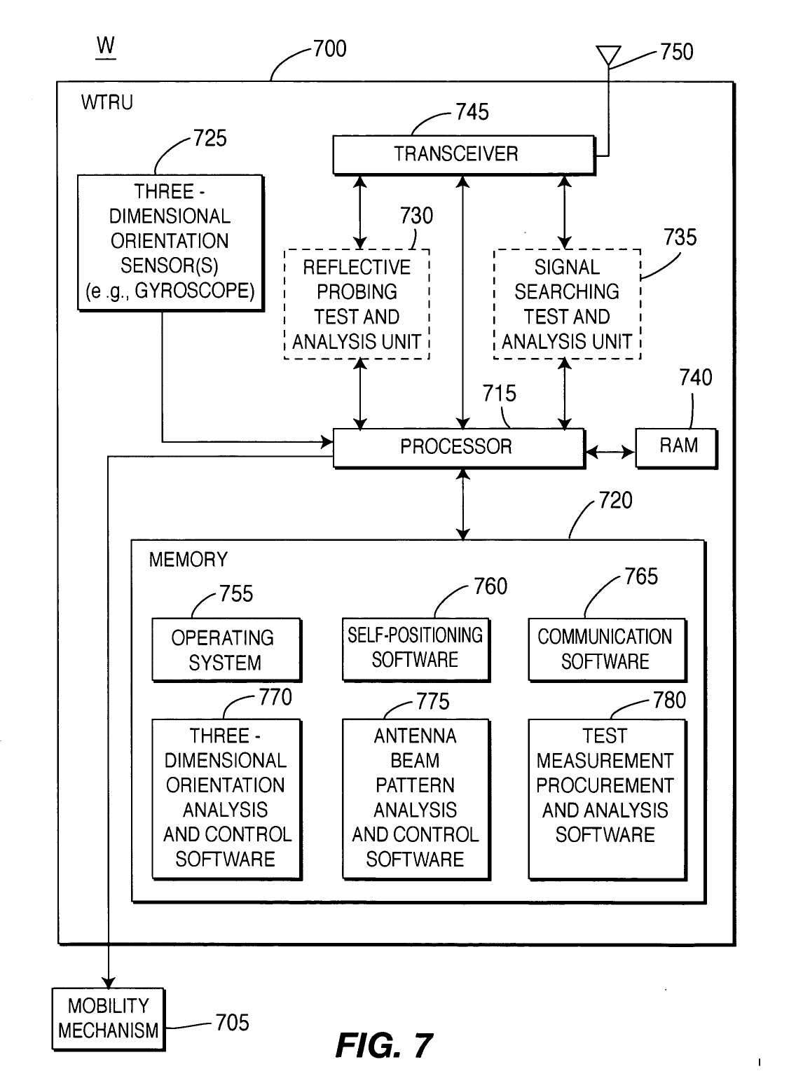

As shown in FIG. 7, each self-positioning transceiver W, (i.e., W1-W12), shown in the wireless communication systems 500 and 600 of FIGS. 5 and 6, includes a WTRU 700 and a mobility mechanism 705. The mobility mechanism 705 is substantially the same as the mobility mechanism 115 of the prior art self-positioning transceiver T shown in FIG. 1B. The mobility mechanism 705 permits the self-positioning transceiver W to adjust its position as necessary to create and/or maintain a particular communication link. Examples of the mobility mechanism 705 include, but are not limited to, radio-controlled land-craft, aircraft, and watercraft. Additional details regarding the mobility mechanism 705 are described in U.S. Patent Application Publication 2003/0124977 entitled “Self-Positioning Wireless Transceiver System and Method,” which was issued to Smith et al. on Jul. 3, 2003 and is incorporated by reference in its entirety herein.

As shown in FIG. 7, the WTRU 700 includes a processor 715, a memory 720, at least one three-dimensional orientation sensor 725, (e.g., a gyroscope), an optional reflective probing test and analysis unit 730, an optional signal searching test and analysis unit 735, a RAM 740, a transceiver 745 and a beam forming antenna 750. The memory 720 includes an operating system 755, self-positioning software 760, and communication software 765, similar to the operating system and software found in the memory 130 of the prior art self-positioning transceiver T shown in FIG. 1B. However, the memory 720 of the self-positioning transceiver W further includes three-dimensional orientation analysis and control software 770, antenna beam pattern analysis and control software 775, and test measurement procurement and analysis software 780, which are used by the processor 715 in conjunction with at least one three-dimensional orientation sensor(s) 725, the optional reflective probing test and analysis unit 730, and the optional signal searching test and analysis unit 735 to advance the prior art.

During the operation of the WTRU 700, the processor 715 employs the self-positioning software 760 in the memory 720 to identify adjustments to the positions of neighboring self-positioning transceivers W, based on one or more received signals, in an attempt to optimize the quality of communication links between such transceivers W. Based on the identified adjustments, the processor 715 issues commands to the mobility mechanism 705 to adjust the position of the self-positioning transceiver W.

The transceiver 745 is communicatively coupled to the processor 715 and the beam forming antenna 750. The processor 715 employs the communication software 765 to process communication data signals received and transmitted via the beam forming antenna 750.

The RAM 740 is communicatively coupled to the processor 715 and is generally used to maintain self-positioning transceiver specific operational data including one or more of, but not limited to, the number of neighboring self-positioning transceivers, destination devices 510, 610 within communication range of the wireless self-positioning wireless communication system 500, 600, communication link quality parameters relating to the quality of individual communication links with neighboring self-positioning transceivers, the number of self-positioning transceivers necessary to communicatively link the source device 505, 605, to different destination devices 510, 610, aggregate communication link quality between the source device 505, 605 and the destination device 510, 610, parameters relating to the location of the self-positioning transceiver W relative to the source device 505, 605 and directional data with reference to neighboring self-positioning transceivers.

The three-dimensional orientation sensor(s) 725 is communicatively coupled to the processor 715 and is generally used to determine the true orientation of the transceiver W to the Earth coordinate system. The three-dimensional orientation sensor(s) 725 may be a single physical tracking device, a plurality of separate sensors mounted orthogonal to each other, or a plurality of non-orthogonal sensors, as described above.

As shown in FIGS. 4a and 4b, different orientations of the transceiver W cause the three-dimensional orientation sensor(s) 725 in the WTRU 700 to report the amount of force being exerted in three dimensions, (i.e., F_{X}, F_{Y} and F_{Z}). The three-dimensional orientation analysis and control software 770 in the memory 720 operates in conjunction with the three-dimensional orientation sensor(s) 725 and the processor 715 to determine three-dimensional axis rotational equations, deviations from the true Earth orientation and correction factors, (i.e., Euler angles). The three-dimensional orientation analysis and control software 770 compares readings provided by the three-dimensional orientation sensor(s) 725 to an established nominal orientation, (e.g., true Earth orientation), to determine the deviation in orientation of the transceiver W from the nominal orientation.

The three-dimensional orientation analysis and control software 770 may control the mobility mechanism 705 via the processor 715 to return the transceiver W to its nominal position, as shown in FIGS. 3a and 4a.

The antenna beam pattern analysis and control software 775 and test measurement procurement and analysis software 780 may be used to control the transceiver 745 and the beam forming antenna 750 via the processor 715. Furthermore, the beam patterns formed by the beam forming antenna 750, and/or the transmission and receiver characteristics of the transceiver 745 and/or the beam forming antenna 750, may be adjusted based on the results of test measurements, (e.g., VSWR determined by reflective probing, boresight determined by signal searching, or the like), performed by the optional reflective probing test and analysis unit 730 or the optional signal searching test and analysis unit 735.

In an alternate embodiment, the position and/or orientation of the transceiver W may be changed by the mobility mechanism 705 based on the orientation sensed by the three-dimensional orientation sensor(s) 725, and/or the measurements performed by one or both of the optional reflective probing test and analysis unit 730 and the optional signal searching test and analysis unit 735.

While the present invention has been described in terms of the preferred embodiment, other variations which are within the scope of the invention as outlined in the claims below will be apparent to those skilled in the art.

What is claimed is:

1. In a wireless communication system including a plurality of self-positioning transceivers which form at least one communication link between a source device and a destination device, each transceiver having a radio frequency (RF) beam antenna, a method of compensating for degradation of the communication link when at least one of the transceivers changes position, the method comprising:
(a) receiving movement information indicating that at least one of the transceivers of the communication link is moving or is going to move in at least one of three possible dimensions; and
(b) in response to step (a), at least one of the transceivers adjusting its respective antenna's RF beam pattern to adequately maintain the communication link when the movement occurs.

2. The method of claim 1 wherein the information indicates an absolute or relative amount of time until the movement is to occur.

3. The method of claim 1 wherein the information indicates an absolute or relative change in transceiver position.

4. The method of claim 1 wherein the information indicates an absolute or relative velocity in each of the three possible dimensions.

5. The method of claim 1 wherein the information indicates a schedule of times associated with the movement.

6. The method of claim 1 wherein the information indicates a margin of error associated with the movement.

7. The method of claim 1 wherein the information indicates a change in antenna beam pattern characteristics of at least one of the transceivers.

8. The method of claim 7 wherein the antenna beam pattern characteristics include signal gain.

9. The method of claim 7 wherein the antenna beam pattern characteristics include beam width.

10. The method of claim 7 wherein the antenna beam pattern characteristics include at least one of elevation and azimuth.

11. The method of claim 7 wherein the antenna beam pattern characteristics include boresight direction.

12. In a wireless communication system including a plurality of self-positioning transceivers which form at least one communication link between a source device and a destination device, each transceiver having a radio frequency (RF) beam antenna, a method of compensating for degradation of the communication link when at least one of the transceivers changes position, the method comprising:
(a) receiving movement information indicating that at least one of the transceivers of the communication link is moving or is going to move in at least one of three possible dimensions; and
(b) in response to step (a), at least one of the transceivers adjusting its respective communication link characteristics to adequately maintain the communication link when the movement occurs.

13. The method of claim 12 wherein the information indicates an absolute or relative amount of time until the movement is to occur.

14. The method of claim 12 wherein the information indicates an absolute or relative change in transceiver position.

15. The method of claim 12 wherein the information indicates an absolute or relative velocity in each of the three possible dimensions.

16. The method of claim 12 wherein the information indicates a schedule of times associated with the movement.

17. The method of claim 12 wherein the information indicates a margin of error associated with the movement.

18. The method of claim 12 wherein the information indicates a change in antenna beam pattern characteristics of at least one of the transceivers.

19. The method of claim 18 wherein the antenna beam pattern characteristics include signal gain.

20. The method of claim 18 wherein the antenna beam pattern characteristics include beam width.

21. The method of claim 18 wherein the antenna beam pattern characteristics include at least one of elevation and azimuth.

22. The method of claim 18 wherein the antenna beam pattern characteristics include boresight direction.

23. In a wireless communication system including a plurality of self-positioning transceivers which interconnect via a plurality of sublinks to form at least one communication link between a source device and a destination device, each transceiver having a radio frequency (RF) beam antenna, a method of compensating for degradation of the communication link when at least one of the transceivers disengages from the remaining transceivers, the method comprising:
(a) receiving movement information indicating that a gap in the communication link has occurred or will occur because at least one of the transceivers of the communication link has disengaged or is going to disengage from the communication link; and
(b) in response to step (a), determining that there is no other transceiver available to fill the gap and reconfiguring the communication link by establishing a new sublink to eliminate the gap, wherein information regarding the relative positions of the remaining transceivers and link relationships with the disengaged transceiver is used to determine the characteristics of the new sublink.

24. A wireless communication system comprising:
(a) a source device;
(b) a destination device; and
(c) a network including a plurality of self-positioning transceivers which form a communication link between the source device and the destination device, each transceiver having a radio frequency (RF) beam antenna, wherein the system receives movement information indicating that at least one of the transceivers of the communication link is moving or is going to move in at least one of three possible dimensions, and in response thereto, at least one of the transceivers adjusts its respective antenna's RF beam pattern to adequately maintain the communication link when the movement occurs.

25. The system of claim 24 wherein the information indicates an absolute or relative amount of time until the movement is to occur.

26. The system of claim 24 wherein the information indicates an absolute or relative change in transceiver position.

27. The system of claim 24 wherein the information indicates an absolute or relative velocity in each of the three possible dimensions.

28. The system of claim 24 wherein the information indicates a schedule of times associated with the movement.

29. The system of claim 24 wherein the information indicates a margin of error associated with the movement.

30. The system of claim 24 wherein the information indicates a change in antenna beam pattern characteristics of at least one of the transceivers.

31. The system of claim 30 wherein the antenna beam pattern characteristics include signal gain.

32. The system of claim 30 wherein the antenna beam pattern characteristics include beam width.

33. The system of claim 30 wherein the antenna beam pattern characteristics include at least one of elevation and azimuth.

34. The system of claim 30 wherein the antenna beam pattern characteristics include boresight direction.

35. A wireless communication system comprising:
(a) a source device;
(b) a destination device; and
(c) a plurality of self-positioning transceivers which form at least one communication link between the source device and the destination device, each transceiver having a radio frequency (RF) beam antenna, wherein the system receives movement information indicating that at least one of the transceivers of the communication link is moving or is going to move in at least one of three possible dimensions, and in response thereto, at least one of the transceivers adjusts its respective communication link characteristics to adequately maintain the communication link when the movement occurs.

36. The system of claim 35 wherein the information indicates an absolute or relative amount of time until the movement is to occur.

37. The system of claim 35 wherein the information indicates an absolute or relative change in transceiver position.

38. The system of claim 35 wherein the information indicates an absolute or relative velocity in each of the three possible dimensions.

39. The system of claim 35 wherein the information indicates a schedule of times associated with the movement.

40. The system of claim 35 wherein the information indicates a margin of error associated with the movement.

41. The system of claim 35 wherein the information indicates a change in antenna beam pattern characteristics of at least one of the transceivers.

42. The system of claim 41 wherein the antenna beam pattern characteristics include signal gain.

43. The system of claim 41 wherein the antenna beam pattern characteristics include beam width.

44. The system of claim 41 wherein the antenna beam pattern characteristics include at least one of elevation and azimuth.

45. The system of claim 41 wherein the antenna beam pattern characteristics include boresight direction.

46. A wireless communication system comprising:
(a) a source device;
(b) a destination device; and
(c) a plurality of self-positioning transceivers which interconnect via a plurality of sublinks to form a communication link between the source device and the destination device, each transceiver having a radio frequency (RF) beam antenna, wherein movement information is received which indicates that a gap in the communication link has occurred or will occur because at least one of the transceivers of the communication link has disengaged or is going to disengage from the communication link, it is determined that there is no other transceiver available to fill the gap, and the communication link is reconfigured by establishing a new sublink to eliminate the gap, whereby information regarding the relative positions of the remaining transceivers and link relationships with the disengaged transceiver is used to determine the characteristics of the new sublink.

47. A self-positioning transceiver comprising:
(a) a mobility mechanism; and
(b) a wireless transmit/receive unit (WTRU) for adjusting at least one of the position and three-dimensional orientation of the self-positioning transceiver by controlling the mobility mechanism, wherein the WTRU comprises:
(i) a processor in communication with the mobility mechanism; and
(ii) a radio frequency (RF) beam forming antenna in communication with the transceiver; and
(iii) at least one three-dimensional orientation sensor in communication with the processor, wherein the antenna forms beams based on the true three-dimensional orientation of the transceiver as determined by the sensor.

48. A self-positioning transceiver comprising:
(a) a mobility mechanism; and
(b) a wireless transmit/receive unit (WTRU) for adjusting at least one of the position and three-dimensional orientation of the self-positioning transceiver by controlling the mobility mechanism, wherein the WTRU comprises:
(i) a processor in communication with the mobility mechanism;
(ii) a radio frequency (RF) beam forming antenna in communication with the transceiver; and
(iii) means for performing reflective probing tests using the antenna, wherein the antenna forms beams based on the reflective probing test results.

49. A self-positioning transceiver comprising:
(a) a mobility mechanism; and
(b) a wireless transmit/receive unit (WTRU) for adjusting at least one of the position and three-dimensional orientation of the self-positioning transceiver by controlling the mobility mechanism, wherein the WTRU comprises:
(i) a processor in communication with the mobility mechanism;
(ii) a radio frequency (RF) beam forming antenna in communication with the transceiver; and
(iii) means for performing boresight signal searching tests, wherein the antenna forms beams based on the boresight signal searching test results.

50. A self-positioning transceiver comprising:
(a) a mobility mechanism; and
(b) a wireless transmit/receive unit (WTRU) for adjusting at least one of the position and three-dimensional orientation of the self-positioning transceiver by controlling the mobility mechanism, wherein the WTRU comprises:
(i) a processor in communication with the mobility mechanism; and
(ii) a radio frequency (RF) beam forming antenna in communication with the transceiver; and
(iii) at least one three-dimensional orientation sensor in communication with the processor, wherein the processor instructs the mobility mechanism to change at least one of the position and three-dimensional orientation of the self-positioning transceiver based on the true three-dimensional orientation of the WTRU as determined by the sensor.

51. A self-positioning transceiver comprising:
(a) a mobility mechanism; and
(b) a wireless transmit/receive unit (WTRU) for adjusting at least one of the position and three-dimensional orientation of the self-positioning transceiver by controlling the mobility mechanism, wherein the WTRU comprises:
(i) a processor in communication with the mobility mechanism;
(ii) a radio frequency (RF) beam forming antenna in communication with the transceiver; and
(iii) means for performing reflective probing tests using the antenna, wherein the processor instructs the mobility mechanism to change at least one of the position and three-dimensional orientation of the self-positioning transceiver based on the reflective probing test results.

52. A self-positioning transceiver comprising:
(a) a mobility mechanism; and
(b) a wireless transmit/receive unit (WTRU) for adjusting at least one of the position and three-dimensional orientation of the self-positioning transceiver by controlling the mobility mechanism, wherein the WTRU comprises:
(i) a processor in communication with the mobility mechanism;
(ii) a radio frequency (RF) beam forming antenna in communication with the transceiver; and
(iii) means for performing boresight signal searching tests, wherein the processor instructs the mobility mechanism to change at least one of the position and three-dimensional orientation of the self-positioning transceiver based on the boresight signal searching test results.

53. In a wireless communication system including a plurality of self-positioning transceivers which form at least one communication link between a source device and a destination device, each transceiver having a radio frequency (RF) beam forming antenna, a method of compensating for degradation of the communication link, the method comprising:
(a) determining the true orientation of the transceiver with respect to an established coordinate system; and
(b) adjusting the pattern of at least one beam formed by the antenna based on the true orientation of the transceiver.

54. The method of claim 53 further comprising:
(c) establishing a nominal orientation; and
(d) determining a difference in orientation between the true orientation of the transceiver and the nominal orientation, wherein the pattern of the at least one beam formed by the antenna is adjusted based on the difference in orientation between the true orientation of the transceiver and the nominal orientation.

55. A wireless communication system comprising:
(a) a source device;
(b) a destination device; and
(c) a plurality of self-positioning transceivers which form at least one communication link between the source device and the destination device, each transceiver having a radio frequency (RF) beam antenna, wherein the true orientation of each transceiver is determined with respect to an established coordinate system, and the pattern of at least one beam formed by the antenna is adjusted based on the true orientation of the transceiver.

56. The system of claim 55 wherein each WTRU comprises:
(d) means for establishing a nominal orientation; and
(e) means for determining a difference in orientation between the true orientation of the transceiver and the nominal orientation, wherein the pattern of the at least one beam formed by the antenna is adjusted based on the difference in orientation between the true orientation of the transceiver and the nominal orientation.
